(19) United States
(12) Patent Application Publication
(10) Pub. No.: US 2012/0198019 A1
(43) Pub. Date: Aug. 2, 2012

(54) WEB SERVICE SUPPORT FOR BULK ITEM EXPORT/IMPORT

(75) Inventors: Robin Thomas, Kirkland, WA (US); Paul Wimmer, Maple Valley, WA (US); Venkateswara Ayyadevara, Sammamish, WA (US); Harvey Rook, Newcastle, WA (US)

(73) Assignee: MICROSOFT CORPORATION, Redmond, WA (US)

(21) Appl. No.: 13/015,961

(22) Filed: Jan. 28, 2011

(51) Int. Cl. G06F 15/16

(52) U.S. Cl. 709/217

(57) ABSTRACT

A method for migrating, archiving, or backing-up data between a first device and a second device hosting a communication application in a networked computing environment. The method includes retrieving mailbox data from the second device, the mailbox data includes messaging data and configuration data of the communication application associated with the mailbox data. The method also includes mapping the mailbox data from a first data format to a second data format, and transferring the mapped mailbox data to the first device as a first file.

### BACKGROUND

Access to an email system for the purpose of exporting/importing messaging data in bulk is typically performed on a per-item basis. A developer may therefore be required to manage a large corpus of code to implement a multitude of item-specific method calls for a given export/import data migration process. However, such practice is inefficient and does not properly scale in proportion with advances in email system technologies.

### SUMMARY

In one aspect, a method for migrating data between a first device and a second device hosting a communication application in a networked computing environment is disclosed. The method includes: retrieving mailbox data from the second device, wherein the mailbox data comprises user-specific messaging data and configuration data of the communication application associated with the mailbox data; mapping the mailbox data from a first data format to a second data format; and transferring the mapped mailbox data to the first device as a first file.

In another aspect, a computing device including a processing unit and a system memory connected to the processing unit disclosed in which the system memory includes instructions that, when executed by the processing unit, cause the processing unit to implement a web service including an export module and an import module programmed for migrating a mailbox between a first device and a second device hosting a communication server in a networked computing environment. The export module is programmed to: receive an export method invocation; retrieve a mailbox structure from the second device in response to the received export method invocation, the mailbox structure includes user-specific messaging data and configuration data of the communication server associated with the mailbox structure; map the mailbox structure from a first data format to a binary large object format; and transfer the mailbox structure to the first device as a first file. The import module is programmed to: receive an import method invocation; retrieve the first file from the first device in response to the received import method invocation; transform the first file from the binary large object format to the first data format to reconstitute the mailbox structure; and transfer the reconstituted mailbox structure to the second device.

In yet another aspect, a computer readable storage medium having computer-executable instructions is discloses that, when executed by a computing device, cause the computing device to perform steps including: retrieving mailbox data from a second device, the mailbox data includes user-specific messaging data selected from the group: email items, appointment items, user-defined items, calendar items, task items, contact items, and journal items; and configuration data of a communication application associated with the mailbox data selected from the group: auditing policies, archiving policies, saved views, and permissions; mapping the mailbox data from a first data format to a second data format; transferring the mapped mailbox data to a first device as a first file; retrieving the first file from the first device; transforming the first file from the second data format to the first data format to reconstitute the mailbox data; transferring the reconstituted mailbox data to the second device; receiving a pause message at the computing device; in response to receiving the pause message, the web service suspending retrieval of the mailbox data from the second device; receiving a resume message at the computing device; and in response to receiving the resume message, the web service continuing retrieval of the mailbox data from the second device starting at a location designated by a pointer.

This Summary is provided to introduce a selection of concepts, in a simplified form, that are further described below in the Detailed Description. This Summary is not intended to identify key or essential features of the claimed subject matter, nor is it intended to be used in any way to limit the scope of the claimed subject matter.

### DESCRIPTION OF THE DRAWINGS

Aspects of the present disclosure may be more completely understood in consideration of the following detailed description of various embodiments in connection with the accompanying drawings.

FIG. 1 shows an example networked computing environment.

FIG. 2 shows an example general purpose computing device.

FIG. 3 shows an example schematic block diagram illustrating example communications between devices of the networked computing environment of FIG. 1.

FIG. 4 shows a flowchart of an example method for exporting a full fidelity copy of a mailbox hosted by a communication system.

FIG. 5 shows a flowchart of an example method for importing a full fidelity copy of a mailbox hosted by a communication system.

FIG. 6 shows a flowchart of an example method for merging back-up copies of a mailbox hosted by a communication system.

FIG. 7 shows an example user interface for a system configured for a full fidelity import/export of a mailbox hosted by a communication system.

### DETAILED DESCRIPTION

The present disclosure is generally directed to systems and methods for exporting and importing data hosted by a communication system in a networked computing environment.

In example embodiments described herein, a web service is configured to generate a full fidelity representation of a mailbox hosted by the communication system, and return the mailbox representation to a network accessible computing device using a single “export” web method call. The mailbox representation is user-specific and includes user-specific messaging data as well as configuration and system data associated with the mailbox. The web service is additionally configured to retrieve and write the mailbox representation to the communication system for a lossless data restore using a single “import” web method call.

Although not so limited, an appreciation of the various aspects of the present disclosure will be understood in the view of the examples provided below.

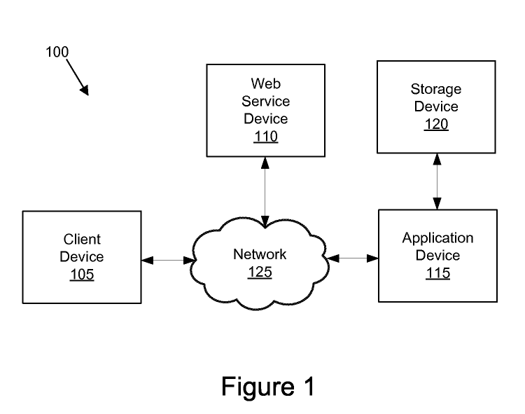

Referring now to FIG. 1, an example networked computing environment 100 is shown. The networked computing environment 100 includes a client device 105, a web service device 110, a application device 115, a storage device 120, and a network 125. Other embodiments are possible. For example, the networked computing environment 100 may generally include more or fewer devices, networks, and other components as desired.

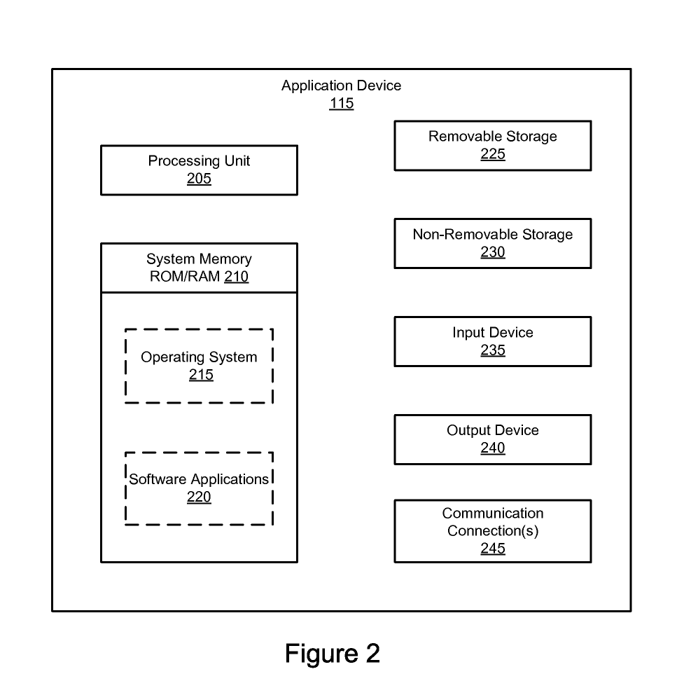

The client device 105, web service device 110, and application device 115 are computing devices, described further below in connection with FIG. 2.

In example embodiments, the web service device 110 is configured to implement a web service that dynamically interacts with other web accessible applications and services based upon open standards including Hypertext Transfer Protocol (HTTP), Extensible Markup Language (XML), Simple Object Access Protocol (SOAP), Web Services Description Language (WSDL), and others. In one embodiment, the web service device 110 includes an interface described in the WSDL format, an XML-based language used for defining the capabilities of web services, as well as protocols and formats used by respective web services. Other embodiments are possible.

When a client (e.g., client device 105) wants to use the web service as hosted by the web service device 110, the client queries the web service, which returns a WSDL description to the client to enable the client to use the service. Communications between the client and the web service typically uses the SOAP protocol over HTTP. Other embodiments are possible. For example, in another implementation, the JavaScript Object Notation (JSON) data-interchange format may be used to support data transmission between the client and the web service. Still other embodiments are possible.

The application device 115 is a business server that implements business processes. Example business processes include messaging and communications process, collaboration processes, data management processes, and others. A SHAREPOINT® collaboration server from Microsoft Corporation of Redmond, Wash. is an example of a business server that implements business processes in support of collaboration, file sharing and web publishing. An Exchange Server, also from Microsoft Corporation, is an example of a business server that implements messaging and collaborative business processes in support of electronic mail, calendaring, contacts, tasks features, etc. Other business processes are possible.

In some embodiments, the web service device 110 and/or the application device 115 respectively include a plurality of interconnected server devices operating together in a “Farm” configuration to implement web-based processes. Other embodiments of the web service device 110 and the application device 115 are possible.

The storage device 120 is a data storage device, such as a relational database or any other type of persistent data storage device. The storage device 120 stores data in a predefined format such that the application device 115 can query, modify, and manage data stored thereon. One example of such a data storage device includes mailbox stores and address services such as an ACTIVE DIRECTORY® directory service from Microsoft Corporation. Other embodiments of the storage device 120 are possible.

The network 125 is a bi-directional data communication path for data transfer between one or more devices. In the example embodiment, the network 125 establishes a communication path for selective data transfer between the respective client device 105, web service device 110, and application device 115. In general, the network 125 can be of any of a number of wireless or hardwired WAN, LAN, Internet, or other packet-based communication networks such that data can be transferred among the elements of the example networked computing environment 100. Other embodiments of the network 125 are possible.

Referring now to FIG. 2, the application device 115 is shown in detail. The application device 115 is a computing device. Examples of computing devices include a desktop computer, a laptop computer, a notebook computer, a server computer, a personal data assistant, a smartphone, a cellular phone, and other types of computing devices.

The application device 115 includes at least one processing unit 205 and system memory 210. The system memory 210 can store an operating system 215 for controlling the operation of the application device 115 and/or another computing device. One example operating system is the WINDOWS® operating system from Microsoft Corporation, or a server, such as the Exchange server, SHAREPOINT® collaboration server, and others.

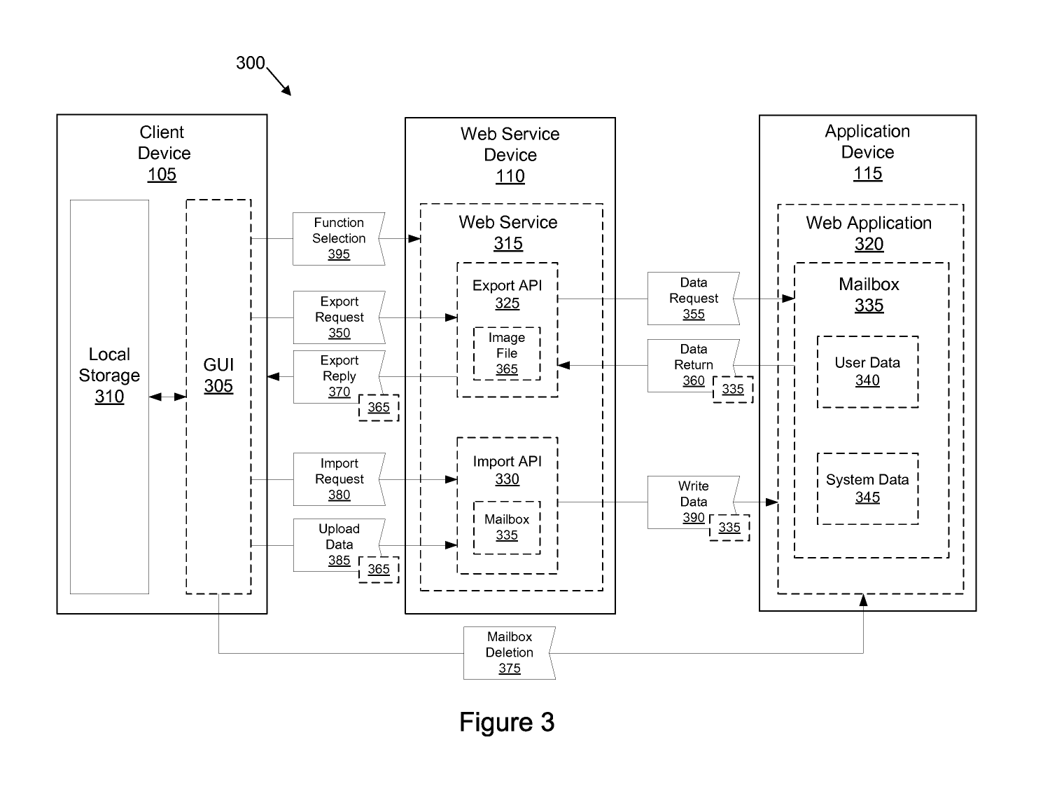

The system memory 210 may also include one or more software applications 220 and may include program data. Software applications 220 may include many different types of single and multiple-functionality programs, such as an electronic mail program, a calendaring program, an Internet browsing program, a spreadsheet program, a program to track and report information, a word processing program, an instant messaging program, a web conferencing service program, and many others. One example program is the Office suite of applications from Microsoft Corporation. Another example program is a graphical user interface configured to interact with and/or invoke functionality of other programs residing on and/or external to the application device 115. An example of such a graphical user interface is described below in connection with FIGS. 3-7.

The system memory 210 can include computer-readable media. Examples of computer-readable media include computer-readable storage media and communication media.

Computer-readable storage media is physical media that is distinguished from communication media.

Computer-readable storage media can include physical volatile and nonvolatile, removable and non-removable media implemented in any method or technology for storage of information, such as computer-readable instructions, data structures, program modules, or other data. Computer-readable storage media can also include, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the application device 115. Any such computer storage media may be part of or external to the application device 115. Such storage is illustrated in FIG. 2 by removable storage 225 and non-removable storage 230.

Communication media may typically be embodied by computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, communication media includes wired media such as a wired network or direct-wired connection, and wireless media such as acoustic, RF, infrared and other wireless media.

The application device 115 can also have any number and type of input devices 235 and output devices 240. Example input devices 235 include a keyboard, mouse, pen, voice input device, touch input device, and others. Example output devices 240 include a display, speakers, printer, and others. The application device 115 can also include a communication connection 245 configured to enable communications with other computing devices over a network (e.g., network 125) in a distributed computing system environment.

The client device 105 and the web service device 110 of the networked computing environment 100 shown FIG. 1 are configured in a manner similar to the application device 115 described above.

Referring now to FIG. 3, a schematic block diagram 300 illustrates example communications between the client device 105, web service device 110, and application device 115 of FIG. 1.

In the example shown, the client device 105 includes a graphical user interface (GUI) 305 and a local storage 310, the web service device 110 includes a web service 315, and the application device 115 includes a web application 320. The example web service 315 includes an export application programming interface (API) 325 and an import API 330. The example web application 320 includes a mailbox 335 comprising user data 340 and system data 345. Other embodiments of the diagram 300 are possible. For example, the diagram 300 may generally include more or fewer devices, and other components as desired. For example, in some embodiments, the web service 315 and the web application 320 are included on a single device. Still other embodiments are possible.

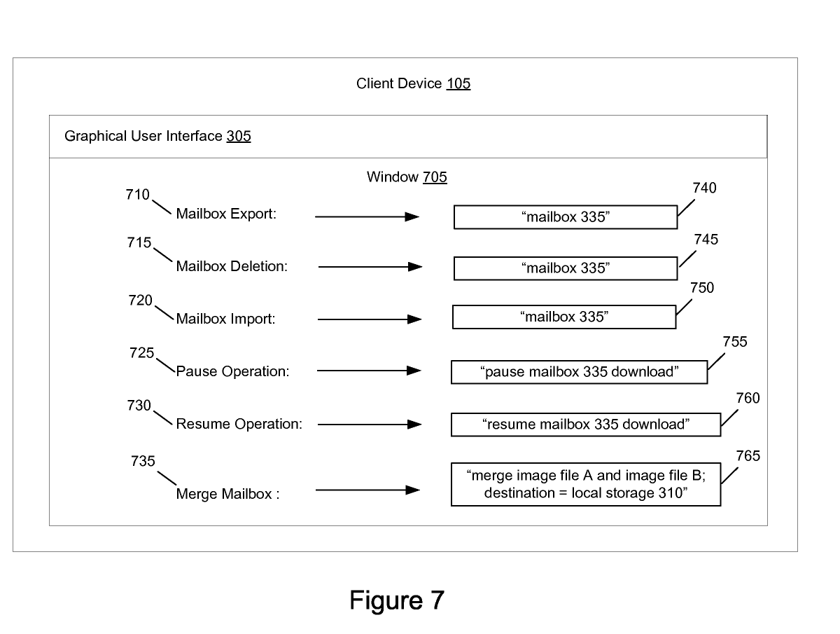

The GUI 305 of the client device 105 includes logical modules of software executing on the client device 105 configured for enabling a user (e.g., an administrator) to interact with and invoke functionality of the web service 315 and the web application 320. An example embodiment of the GUI 305 is described further below in connection with FIG. 7. The local storage 310 includes physical read/write computer-readable storage media that is accessible to client device 105 and the GUI 305.

The web service 315 includes logical modules of software executing on the web service device 110 configured for dynamically interacting with the GUI 305 and the web application 320. More specifically, the export API 325 of the web service 315 is configured to support data export messaging including receiving a data export invocation message from the client device 105, downloading a full fidelity representation of the mailbox 335 (i.e., user data 340 and system data 345) from the web application 320 in response to the received data export invocation message, encoding the representation of the mailbox 335 into a single opaque file, and returning the encoded file to the client device 105, as described in further detail below.

The import API 330 of the web service 315 is configured to support data import messaging including receiving a data import invocation message from the client device 105, uploading a full fidelity representation of the mailbox 335 (i.e., user data 340 and system data 345) from the local storage 310 in response to the received data import invocation message, decoding the full fidelity representation of the mailbox 335, and writing the decoded data to the web application 320, also described in further detail below.

The web application 320 includes logical modules of software executing on the application device 115 configured for implementing business processes in support of email and other electronic messaging. In example embodiments, the mailbox 335 is a user-specific repository in which the user data 340 generally includes user-specific messaging data, and the system data 345 generally includes configuration and system data of the web application 320.

Examples of user-specific messaging data include email items, appointment items, user-defined items, calendar items, task items, contact items, journal items, etc. Examples of configuration and system data include auditing policies, archiving policies, saved views, permissions, etc. In this manner, the user data 340 and system data 345 together represent an entirety of the items, properties, and settings in the mailbox 335. In example embodiments, the term “full fidelity” at least encompasses an entirety items, properties, and settings in a user-specific repository (e.g., mailbox 335).

Other embodiments of the web application 320 are possible. For example, the web application 320 may include a plurality of mailboxes each respectively corresponding to a single user of a plurality users registered with the web application 320 (e.g., an Exchange Server enterprise implementation).

As mentioned above, the export API 325 of the web service 315 is configured to support data export messaging. In example embodiments, data export messaging within the diagram 300 initially includes transfer of an export request message 350 to the web service 315 from the GUI 305 to initiate downloading of a full fidelity representation of the mailbox 335.

More specifically, the export API 325 is configured to receive and interpret the export request message 350 and transfer a data request message 355 to the web application 320. The web application 320 is configured to receive and interpret the data request message 355 and permit the export API 325 to retrieve the user data 340 and the system data 345 of the mailbox 335 in accordance with the export request message 350. In the example shown, the user data 340 and system data 345 of the mailbox 335 are symbolically shown being transferred to the export API 325 as appended to a data return message 360.

The export API 325 is configured to receive and interpret the data return message 360 and encode or map the user data 340 and system data 345 of the mailbox 335 to an image file 365. In one embodiment, mapping of the user data 340 and system data 345 of the mailbox 335 to the image file 365 corresponds to forming a binary large object, a collection of binary data that represents the user data 340 and system data 345 of the mailbox 335. However, other embodiments are possible. For example, the mapping or encoding of the user data 340 and system data 345 of the mailbox 335 may generally include transformation of the data in the mailbox 335 to any other form of organized data.

Following mapping of the user data 340 and system data 345 of the mailbox 335 to the image file 365, the export API 325 is configured to generate an export reply message 370 and transfer the export reply message 370 to the client device 105. In the example shown, the image file 365 is symbolically shown as appended the export reply message 370. In one embodiment, the image file 365 is subsequently transferred to the local storage 310 as a back-up file of the mailbox 335. However, other embodiments are possible. For example, the image file 365 can generally be stored to any type of properly configured network accessible storage external to the client device 105 (e.g., storage area network (SAN), etc.).

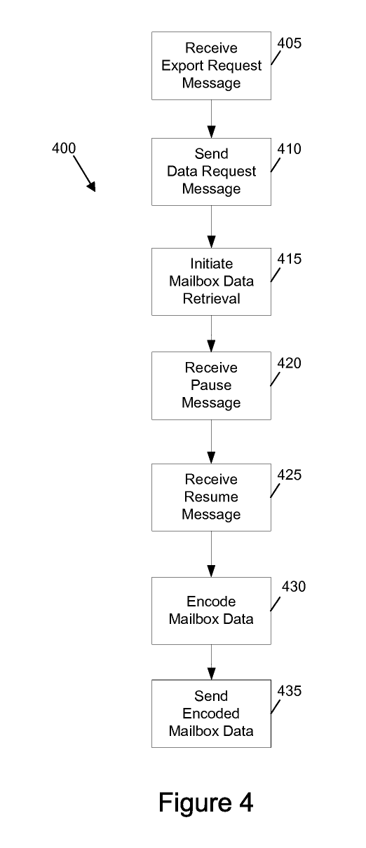

In example embodiments, data export messaging within the example diagram 300 corresponds to a full fidelity back-up of the user data 340 and system data 345 of the mailbox 335 using a single web service method call (i.e., export request message 350) sent from the GUI 305 to the web service 315. Data export messaging within the example diagram 300 of FIG. 3 is described in further detail below in connection with FIG. 4.

As mentioned above, the web service 315 additionally includes an import API 330 configured to support data import messaging. In example embodiments, data import messaging within the example diagram 300 corresponds to a lossless restore of the user data 340 and system data 345 of the mailbox 335 using a single web service method call sent from the GUI 305 to the web service 315. In the following example scenario, data import messaging is described as actions subsequent to the above-described data export messaging. Other embodiments are possible.

In the example shown, data import messaging within the example diagram 300 initially includes transfer of a mailbox deletion message 375 to the web application 320 from the GUI 305 to delete the user data 340 and system data 345 of the mailbox 335. Following deletion of the user data 340 and system data 345 of the mailbox 335, data import messaging proceeds with the transfer of an import request message 380 to the web service 315 from the GUI 305 to initiate uploading of the image file 365 to the web service 315.

More specifically, the import API 330 is configured to receive and authenticate the import request message 380. Upon authentication, the import API 330 is configured to receive the image file 365 from the local storage 310. In the example shown, the image file 365 is symbolically shown being transferred to the import API 330 as appended to an upload data message 385.

Other embodiments are possible. For example, the image file 365 can generally be retrieved from any type of properly configured network accessible storage external to the client device 105 (e.g., storage area network (SAN), etc.). In this manner, retrieval of the image file 365 by the web service 315 does not necessarily include the web service 315 accessing the device (e.g., client device 105) used to form the original import request message (e.g., import request message 380) and/or export request message (e.g., export request message 350).

Following receipt of the image file 365, the import API 330 is configured to decode the image file 365 and map the user data 340 and system data 345 of the mailbox 335 into a format preferred by the web application 320. Following decoding of the image file 365, the import API 330 is configured to generate a write data message 390 and transfer the write data message 390 to the web application 320. In the example embodiment, the user data 340 and system data 345 of the mailbox 335 is symbolically shown as appended to the write data message 390. In this manner, data import messaging within the example diagram 300 corresponds to a lossless data restore of the user data 340 and system data 345 of the mailbox 335 corresponding to a snapshot of the mailbox 335 at the point in time in which the image file 365 was originally acquired. The lossless data restore is accomplished using a single web service call (i.e., import request message 380) sent from the GUI 305 to the web service 315.

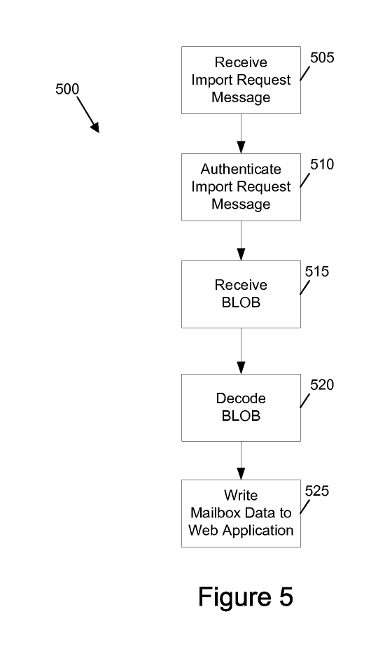

The data import messaging within the example diagram 300 of FIG. 3 is described in further detail below in connection with FIG. 5.

Other messaging scenarios supported by the web service 315 within the example diagram 300 are possible as well. For example, in some embodiments, the web service 315 is configured to receive a function selection message 395 from the GUI 305 for the purpose of implementing various additional functionality of the web service 315. Examples of additional functionality of the web service 315 include a pause/resume functionality and file merge functionality, such as described in further detail below in connection with FIG. 5-7. Other types of additional functionality of the web service 315 are possible.

The example messaging scenarios as implemented by the web service 315 within the example diagram 300 of FIG. 3 are beneficial in many aspects. For example, the disclosed messaging enables a full fidelity back-up and restore of an entire mailbox using a single web service method call. This minimizes developer overhead by removing the necessity of managing mailbox items on a per-item basis by simplifying the code required to back-up and restore a mailbox. In another aspect, the disclosed messaging corresponds to exporting/importing binary streams of data rather than item-by-item structured as XML. This enhances the back-up and restoration of a mailbox in terms of speed and other performance parameters.

Referring now to FIG. 4, an example method 400 for exporting a full fidelity copy of a mailbox hosted by a communication system is shown according to the principles of the present disclosure. In example embodiments, the method 400 is implemented wholly or in part by one or both of the export API 325 and import API 330 of the web service 315 executing on the web service device 110 in communication with the client device 105 and application device 115 configured as described above in connection with FIGS. 1-3. Other embodiments are possible.

The method 400 begins at an operation 405. At operation 405, the web service 315 receives an export request message (e.g., export request message 350) from the client device 105 to initiate downloading of a full fidelity representation of at least one mailbox (e.g., mailbox 335) as managed by the application device 115. In one embodiment, the export request message comprises a SOAP message. However, other embodiments of the export request message are possible.

Operational flow proceeds to an operation 410. At operation 410, the web service 315 sends a data request message (e.g., data request message 355) to the application device 115 requesting access to user data and system data (e.g., user data 340, system data 345) of the at least one mailbox specified in the export request message received at operation 405. In one embodiment, the data request message comprises a SOAP message. However, other embodiments of the data request message are possible.

Operational flow proceeds to an operation 415. At operation 415, the web service 315 begins retrieval of the user data and system data of the at least one mailbox specified in the export request message received at operation 405.

Operational flow proceeds to an operation 420. At operation 420, the web service 315 receives a pause message (e.g., function selection message 395) from the client device 105. Upon receipt of the pause message, the web service 315 ceases acquisition of the user data and system data of the at least one mailbox and maintains a reference pointer designating a location within the user data and system data at which to resume data download data in subsequent operations. The example “pause” functionality as implemented by the web service 315 is described in further detail below in connection with FIG. 7.

Operational flow proceeds to an operation 425. At operation 425, the web service 315 receives a resume message (e.g., function selection message 395) from the client device 105. Upon receipt of the resume message, the web service 315 identifies the location within the user data and system data designated by the reference pointer and completes acquisition of the user data and system data of the at least one mailbox. The example “resume” functionality as implemented by the web service 315 is described in further detail below in connection with FIG. 7.

Operational flow proceeds to an operation 430. At operation 430, the web service 315 encodes the user data and system data of the at least one mailbox to a binary large object (e.g., image file 365). In example embodiments in which the export request message received from the client device 105 at operation 405 includes a request to download a full fidelity representation of more than one mailbox, the web service 315 is configured to encode a single binary large object per specified mailbox at operation 430. Other embodiments are possible. Operational flow then proceeds to an operation 435 at which the web service 315 transfers the binary large object formed at operation 430 to the client device 105.

Referring now to FIG. 5, an example method 500 importing a full fidelity copy of a mailbox hosted by a communication system is shown according to the principles of the present disclosure. In example embodiments, the method 500 is implemented wholly or in part by one or both of the export API 325 and import API 330 of the web service 315 executing on the web service device 110 in communication with the client device 105 and application device 115 configured as described above in connection with FIGS. 1-4.

The method 500 begins at an operation 505. At operation 505, the web service 315 receives an import request message (e.g., import request message 380) from the client device 105 to initiate uploading of a binary large object (e.g., image file 365) to the web service 315. In one embodiment, the import request message comprises a SOAP message. However, other embodiments of the import request message are possible.

Operational flow proceeds to an operation 510. At operation 510, the web service 315 authenticates the import request message received at operation 505. Next, at an operation 515 and following authentication, the web service 315 receives the binary large object as specified by the import request message. Operational flow proceeds to an operation 520. At operation 520, the web service 315 decodes the binary large object and forms the user data and system data of the mailbox into a format preferred by the web application 320. Other embodiments are possible.

Operational flow proceeds to an operation 525. At operation 525, the web service 315 writes the user data and system data of the mailbox as decoded at operation 520 to the web application 320 for a lossless data restore.

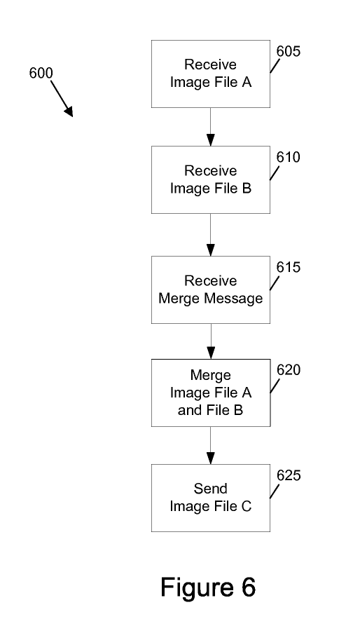

Referring now to FIG. 6, an example method 600 for merging differential images of a mailbox hosted by a communication system is shown. In example embodiments, the method 600 is implemented wholly or in part by one or both of the export API 325 and import API 330 of the web service 315 executing on the web service device 110 in communication with the client device 105 and application device 115 configured as described above in connection with FIGS. 1-5. Other embodiments are possible.

The method 600 begins at an operation 605. At operation 605, the web service 315 receives an image file A from the client device 105. The image file A corresponding to a first back-up copy of the user data 340 and system data 345 of the mailbox 335 as captured at a date/time T1. In the example embodiment, the image file A is a binary large object including a collection of binary data that completely and fully represents the user data 340 and system data 345 of the mailbox 335 at the date/time T1. Additionally, in example embodiments, the image file A is retrieved from the client device 105 via the import API 330 in a manner similar to the data import messaging (e.g., via import request message 380 and upload data message 385) described above with respect to FIG. 3.

Operational flow proceeds to an operation 610. At operation 610, the web service 315 receives an image file B from the client device 105. The image file B corresponding to a second back-up copy of the user data 340 and system data 345 of the mailbox 335 as captured at date/time T2≠T1. In the example embodiment, the image file B is a binary large object including a collection of binary data that completely and fully represents the user data 340 and system data 345 of the mailbox 335 at the date/time T2.

Operational flow proceeds to an operation 615. At operation 615, the web service 315 receives a merge message (e.g., function selection message 395) from the client device 105. The example “merge” functionality as implemented by the web service 315 is described in further detail below in connection with FIG. 7.

Operational flow proceeds to an operation 620. At operation 620, the web service 315 merges the image file A and the image file B to form an image file C. In the example embodiment, merging corresponds to the union or addition of the image file A with the image file B to form the image file C (e.g., image file A+image file B=image file C). In this manner, the web service 315 is configured to support merging of various back-up copies of the user data 340 and system data 345 of the mailbox 335 via “differential copies.” Other embodiments are possible.

Operational flow proceeds to an operation 625. At operation 625, the web service 315 transfers the image file C to the client device 105. Other embodiments are possible. For example, the image file C can be transferred from to any properly configured device accessible to the web service 315 over a network (e.g., network 125). In general, a “destination” functionality for specifying a device for storage of the image file C is supported by the web service 315, as described in further detail below in connection with FIG. 7.

Referring now to FIG. 7, an example embodiment of the GUI 305 described above in connection with FIGS. 1-6 is shown. The GUI 305 includes a window 705 displaying example functionality of the web service 315 available for selection by a user. In the example embodiment, the GUI 305 displays a mailbox export selection 710, a mailbox deletion selection 715, a mailbox import selection 720, a pause operation selection 725, a resume operation selection 730, and a merge mailbox selection 735.

The mailbox export selection 710 is selectable by a user to direct the web service 315 to perform a full fidelity export of user data and system data of a mailbox hosted by the web application 320. In example embodiments, a user enters “mailbox 335” into a first input area 740 to implement a full fidelity back-up of the user data 340 and system data 345 of the mailbox 335 using a single web service method call (i.e., export request message 350) sent from the GUI 305 to the web service 315, as described above. Other embodiments are possible.

The mailbox deletion selection 715 is selectable by a user to direct the web service 315 to perform a deletion of user data and system data of a mailbox hosted by the web application 320. In example embodiments, a user enters “mailbox 335” into a second input area 745 to implement a deletion of the user data 340 and system data 345 of the mailbox 335, as described above. Other embodiments are possible.

The mailbox import selection 720 is selectable by a user to direct the web service 315 to perform a lossless import of user data and system data of a mailbox hosted by the web application 320. In example embodiments, a user enters “mailbox 335” into a third input area 750 to implement a full-fidelity import of the user data 340 and system data 345 of the mailbox 335 using a single web service method call (i.e., import request message 380) sent from the GUI 305 to the web service 315, as described above. Other embodiments are possible.

The pause operation selection 725 is selectable by a user to direct the web service 315 to temporarily or permanently cease operations corresponding to a full fidelity export or lossless import of user data and system data of a mailbox hosted by the web application 320. The web service 315 is configured to maintain a reference pointer designating a location within the user data and system data at which to resume data download or data upload in subsequent operations. Consistent with the example embodiments described above, a user enters “pause mailbox 335 download” into a fourth input area 755 to implement a pause operation to temporarily cease acquisition of the user data 340 and system data 345 of the mailbox 335. Other embodiments are possible.

The resume operation selection 730 is selectable by a user to direct the web service 315 to resume operations corresponding to a full fidelity export or lossless import of user data and system data of a mailbox hosted by the web application 320 (e.g., following user selection of the pause operation selection 725). The web service 315 is configured to identify the location within the user data and system data designated by the reference pointer and resume data download or data upload operations. Consistent with the example embodiments described above, a user enters “resume mailbox 335 download” into a fifth input area 760 to implement a resume operation to complete acquisition of the user data 340 and system data 345 of the mailbox 335. Other embodiments are possible.

The merge mailbox selection 735 is selectable by a user to direct the web service 315 to merge differential images of user data and system data of a mailbox hosted by the web application 320. Consistent with the example embodiments described above, a user enters “merge image file A and image file B” into a sixth input area 765 to implement a merge operation corresponding to the union or addition of the image file A with the image file B to form the image file C (e.g., image file A+image file B=image file C). The user additionally specifies a “destination” for storage of the image file C within sixth input area 765 as “destination=local storage 310.” Other embodiments are possible.

The example embodiments described herein can be implemented as logical operations in a computing device in a networked computing system environment. The logical operations can be implemented as: (i) a sequence of computer implemented instructions, steps, or program modules running on a computing device; and (ii) interconnected logic or hardware modules running within a computing device.

For example, the logical operations can be implemented as algorithms in software, firmware, analog/digital circuitry, and/or any combination thereof, without deviating from the scope of the present disclosure. The software, firmware, or similar sequence of computer instructions can be encoded and stored upon a computer-readable storage medium and can also be encoded within a carrier-wave signal for transmission between computing devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for migrating data between a first device and a second device hosting a communication application in a networked computing environment, the method comprising:
retrieving mailbox data from the second device, wherein the mailbox data comprises user-specific messaging data and configuration data of the communication application associated with the mailbox data;
mapping the mailbox data from a first data format to a second data format; and
transferring the mapped mailbox data to the first device as a first file.

2. The method of claim 1, further comprising:
retrieving the first file from the first device; and
transforming the first file from the second data format to the first data format to reconstitute the mailbox data.

3. The method of claim 2, further comprising the web service transferring the reconstituted mailbox data to the second device.

4. The method of claim 1, further comprising:
receiving a pause message at the computing device; and
in response to receiving the pause message, the web service suspending retrieval of the mailbox data from the second device.

5. The method of claim 4, further comprising the web service generating a pointer designating a location within the mailbox data at which to resume retrieval of the mailbox data.

6. The method of claim 5, further comprising:
receiving a resume message at the computing device; and
in response to receiving the resume message, the web service continuing retrieval of the mailbox data from the second device starting at the location designated by the pointer.

7. The method of claim 1, further comprising:
retrieving the mailbox data from the second device;
mapping the mailbox data from the first data format to the second data format; and
storing the mapped mailbox data as a second file.

8. The method of claim 7, further comprising the web service retrieving the first file from the first device.

9. The method of claim 8, further comprising:
receiving a merge message at the computing device; and
in response to receiving the merge message, the web service combining the first file with the second file to form a third file.

10. The method of claim 9, further comprising the web service transferring the third file to the first device.

11. The method of claim 1, wherein the second data format comprises a binary large object.

12. The method of claim 1, wherein the user-specific messaging data includes one or more items selected from the group comprising: email items, appointment items, user-defined items, calendar items, task items, contact items, and journal items.

13. The method of claim 1, wherein the configuration data includes one or more items selected from the group comprising: auditing policies, archiving policies, saved views, and permissions.

14. A computing device, comprising:
a processing unit; and
a system memory connected to the processing unit, the system memory including instructions that, when executed by the processing unit, cause the processing unit to implement a web service comprising an export module and an import module programmed for migrating a mailbox between a first device and a second device hosting a communication server in a networked computing environment, wherein:
the export module is programmed to:
receive an export method invocation;
retrieve a mailbox structure from the second device in response to the received export method invocation, wherein the mailbox structure comprises user-specific messaging data and configuration data of the communication server associated with the mailbox structure;
map the mailbox structure from a first data format to a binary large object format; and
transfer the mailbox structure to the first device as a first file; and
the import module is programmed to:
receive an import method invocation;
retrieve the first file from the first device in response to the received import method invocation;
transform the first file from the binary large object format to the first data format to reconstitute the mailbox structure; and
transfer the reconstituted mailbox structure to the second device.

15. The computing device of claim 14, wherein the export module is further programmed to:
receive a pause message; and
suspend retrieval of the mailbox structure from the second device in response to the received pause message.

16. The computing device of claim 15, wherein the export module is further programmed to:
receive a resume message; and
continue retrieval of the mailbox structure from the second device in response to the received resume message

17. The computing device of claim 14, wherein:
the export module is further programmed to:
receive a second export method invocation;
retrieve the mailbox structure from the second device in response to the received second export method invocation;
map the mailbox structure from the first data format to the binary large object format; and
store the mapped mailbox structure as a second file in the system memory; and
the import module is further programmed to:
receive a second import method invocation:
retrieve the first file from the first device in response to the received second import method invocation;
receive a merge message;
combine the first file with the second file to form a third file in response to the received merge message; and
transfer the third file to the first device.

18. The computing device of claim 14, wherein the user-specific messaging data includes one or more items selected from the group comprising: email items, appointment items, user-defined items, calendar items, task items, contact items, and journal items; and wherein the configuration data includes one or more items selected from the group comprising: auditing policies, archiving policies, saved views, and permissions.

19. A computer readable storage medium having computer-executable instructions that, when executed by a computing device, cause the computing device to perform steps comprising:
retrieving mailbox data from a second device, wherein the mailbox data comprises user-specific messaging data selected from the group comprising: email items, appointment items, user-defined items, calendar items, task items, contact items, and journal items; and configuration data of a communication application associated with the mailbox data selected from the group comprising: auditing policies, archiving policies, saved views, and permissions;
mapping the mailbox data from a first data format to a second data format;
transferring the mapped mailbox data to a first device as a first file;
retrieving the first file from the first device;
transforming the first file from the second data format to the first data format to reconstitute the mailbox data;
transferring the reconstituted mailbox data to the second device;
receiving a pause message at the computing device;
in response to receiving the pause message, the web service suspending retrieval of the mailbox data from the second device;
receiving a resume message at the computing device; and
in response to receiving the resume message, the web service continuing retrieval of the mailbox data from the second device starting at a location designated by a pointer.

20. The computer readable storage medium of claim 19, wherein the second data format comprises a binary large object.
